(19) United States
(12) Patent Application Publication
(10) Pub. No.: US 2003/0037226 A1
(43) Pub. Date: Feb. 20, 2003

(54) Processor architecture

(75) Inventors: Toru Tsuruta, Kawasaki (JP); Norichika Kumamoto, Kawasaki (JP); Hideki Yoshizawa, Kawasaki (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 10/133,394

(22) Filed: Apr. 29, 2002

Related U.S. Application Data
(63) Continuation of application No. PCT/JP99/JP06030, filed on Oct. 29, 1999.

(51) Int. Cl. G06F 9/00

(52) U.S. Cl. 712/228; 712/235

(57) ABSTRACT

A processor architecture includes a program counter which executes M independent program streams in time division in units of one instruction, a pipeline which is shared by each of the program streams and has N pipeline stages operable at a frequency F, and a mechanism which executes only s program streams depending on a required operation performance, where M and N are integers greater than or equal to one and having no mutual dependency, s is an integer greater than or equal to zero and satisfying s≦M. An apparent number of pipeline stages viewed from each of the program streams is set to N/M so that M parallel processors having an apparent operating frequency F/M are formed.

### BACKGROUND OF THE INVENTION

This application claims the benefit of an International Patent Application No. PCT/JP99/06030 filed Oct. 29, 1999, in the Japanese Patent Office, the disclosure of which is hereby incorporated by reference.

1. Field of the Invention

The present invention generally relates to processor architectures, and more particularly to a processor architecture having a multi-stage pipeline structure.

2. Description of the Related Art

Majority of recent processors have a multi-stage pipeline structure, and an instruction execution latency is large, but a high operation performance is realized by making a throughput be one cycle. In other words, when the throughput is one cycle, it is equivalent to being able to execute instructions amounting to an operating frequency (MHz) in one second, and thus, a technique is employed to reduce a delay time of one stage by sectioning the pipeline.

FIGS. 1A and 1B and FIGS. 2A and 2B are diagrams for explaining the technique for sectioning the pipeline of the processor. FIGS. 1A and 2A show a multi-stage pipeline structure, and FIGS. 1B and 2B show instruction latency. In FIGS. 1A and 2A, P1 through PN and p1 through pn denote pipeline stages, and A through F indicate one program stream. In addition, in FIGS. 1B and 2B, the ordinate indicates the pipeline, and the abscissa indicates the time.

FIGS. 1A and 1B show a case where the pipeline has N stages, the operating frequency is 1/T, the operation performance is 1, and the instruction latency is N cycles. On the other hand, FIGS. 2A and 2B show a case where the pipeline has twice the number of stages compared to the case shown in FIGS. 1A and 1B, that is, the period of the pipeline is ½ that of the case shown in FIGS. 1A and 1B. In the case shown in FIGS. 2A and 2B, the pipeline has 2N stages, the operating frequency is 2/T, the operation performance is 2, and the instruction latency is 2N cycles.

However, when a conditional branch instruction is executed in the processor having the multi-stage pipeline structure, several instructions immediately after the branch instruction are executed regardless of whether or not a branch is made, and the number of instructions executed in this manner is proportional to the number of stages of the pipeline. In this specification, this phenomenon will be referred to as a “delayed jump”, and the number of instructions which are executed in this manner will be referred to as a “delay number”.

The delayed jump becomes a disadvantage because, with respect to the several instructions immediately after the branch instruction, the probability of an effective instruction being implemented is low even if a software developer writes by an assembler, and furthermore, a compiler-dependent situation occurs when the development is made using a high-level language such as the C-language, and the probability of the effective instruction being implemented tends to become lower. In other words, not being able to implement an effective instruction means that a No Operation (NOP) instruction (invalid instruction) is implemented. As a result, a cycle is generated in which the operation cannot be executed, to thereby deteriorate the effective performance of the processor. In other words, when the number of stages of the pipeline is increased, the number of delays of the delayed jump increases, and the number of cycles in which the effective instruction cannot be implemented increases, thereby making it impossible to create an efficient instruction code.

When optimizing the instruction code, it is more advantageous if the number of stages of the pipeline is smaller, but the operating frequency can be increased if the number of stages of the pipeline is increased. Hence, most processors consider the tradeoffs of the former and the latter, and employ the latter. In addition, since there is a limit to further sectioning the pipeline, the techniques recently used to improve the operating frequency of the high-performance processor tend to rely on the improvement of the operating speed coming from the development of the device technology.

Accordingly, there are demands to realize a high-performance processor by reducing the number of delays of the delayed jump while optimizing the instruction code. In view of the above described problems and demands, a high-performance digital signal processor (DSP) architecture has been proposed by Lee et al., “Pipeline Interleaved Programmable DSP's: Architecture”, IEEE Trans. Acoust., Speech, Signal Processing, Vol.35, No.9, September 1987. According to this proposed DSP architecture, a plurality of program streams are executed in time division (interleave) with respect to the DSP having the multi-stage pipeline structure. It has been reported that this enables the pipeline to be shared, and that this has the effect of reducing the number of stages of the pipeline when viewed from each program stream.

Recently, due to further progress made in the development of the high-performance DSPs, the application of the DSPs are no longer limited to audio processing or the like, and the DSPs are now being applied to image processing or the like which treat an extremely large amount of information. For this reason, there are demands for various kinds of processors ranging from a relatively low-performance processors to an extremely high-performance processors.

In the case of the high-performance processor, it is of course possible to sufficiently carry out the audio processing or the like which have a relatively low performance requirement. However, in the case of the high-performance processor, the power consumption is also high. Consequently, when the high-performance processor carries out the audio processing or the like which have the relatively low performance requirement, there was a problem in that the power consumption is considerably high compared to the case where the same audio processing or the like is carried out by a low-performance processor.

### SUMMARY OF THE INVENTION

Accordingly, it is a general object of the present invention to provide a novel and useful processor architecture in which the problem described above is eliminated.

Another and more specific object of the present invention is to provide a processor architecture which executes a program stream depending on a performance requirement, so that the power consumption can be reduced depending on the performance requirement.

Still another object of the present invention is to provide a processor architecture comprising a program counter executing M independent program streams in time division in units of one instruction, a pipeline, shared by each of the program streams, having N pipeline stages operable at a frequency F, and a first mechanism executing only s program streams depending on a required operation performance, where M and N are integers greater than or equal to one and having no mutual dependency, s is an integer greater than or equal to zero and satisfying s≦M, and an apparent number of pipeline stages viewed from each of the program streams is set to N/M so that M parallel processors having an apparent operating frequency F/M are formed. According to the processor architecture of the present invention, it is possible to reduce the power consumption depending on the required performance by executing the program streams to suit the required performance.

The processor architecture may further comprise a second mechanism dynamically starting, stopping and switching each of the program streams. In addition, the first mechanism may include a clock controller which masks clocks supplied to each of the stages of the pipeline in cycles allocated to (M−s) program streams which require no execution.

A further object of the present invention is to provide a processor architecture comprising a program counter executing M independent program streams in time division in units of one instruction, a pipeline, shared by each of the program streams, having N pipeline stages operable at a frequency F, an instruction developing section which develops one instruction into Q parallel instructions, and a first mechanism executing one program stream for every M cycles depending on a required operation performance and selectively executing the Q parallel instructions in remaining (M−1) cycles, where M and N are integers greater than or equal to one and having no mutual dependency, Q is an integer greater than or equal to one and satisfying Q≦M, and an apparent number of pipeline stages viewed from each of the program streams is set to N/M so that M parallel processors having an apparent operating frequency F/M are formed. According to the processor architecture of the present invention, it is possible to reduce the power consumption depending on the required performance by executing the program streams to suit the required performance.

The processor architecture may further comprise a second mechanism dynamically starting, stopping and switching each of the program streams. In addition, the first mechanism may include a clock controller which masks clocks supplied to each of the stages of the pipeline in cycles allocated to (M−s) program streams which require no execution, where s is an integer greater than or equal to zero and satisfying s≦M. Further, the first mechanism may consecutively execute the Q parallel instructions in cycles allocated to (M−s) program streams which require no execution so as to locally execute the instructions at a high speed, where s is an integer greater than or equal to zero and satisfying s≦M.

In each of the processor architectures described above, each of the pipeline stages of said pipeline may include a storage element, and have an operating mode for storing and holding input data in the storage element and an operating mode for bypassing the storage element and outputting the input data.

Another object of the present invention is to provide a processor architecture comprising a pipeline operable at a frequency F and having N pipeline stages, and a mechanism which inputs an instruction for every S cycles depending on a required operation performance and masking clocks supplied to the pipeline in remaining cycles in which no instruction is input, when executing one program stream, where N and S are integers greater than or equal to one and having no mutual dependency, and an apparent number of pipeline stages of the pipeline when viewed from the program stream is set to N/S so that a processor having an apparent operating frequency F/S is formed. According to the processor architecture of the present invention, it is possible to reduce the power consumption depending on the required performance by executing the program streams to suit the required performance.

Each of the pipeline stages of the pipeline may include a storage element, and have an operating mode for storing and holding input data in the storage element and an operating mode for bypassing the storage element and outputting the input data, and the mechanism may mask a clock supplied to the storage element within a pipeline stage which is combinable with a preceding pipeline stage.

Moreover, in each of the processor architectures described above, the pipeline may have an access latency of L cycles, an operating frequency F, and a memory having a structure capable of making a pipeline-like consecutive access, where L≧1, and a memory access latency in one program stream is L/M.

The pipeline may have an access latency of L cycles, and M memories each having a structure capable of making a pipeline-like consecutive access independently with respect to each program stream, where L≧1.

Other objects and further features of the present invention will be apparent from the following detailed description when read in conjunction with the accompanying drawings.

### BRIEF DESCRIPTION OF THE DRAWINGS

FIGS. 1A and 1B are diagrams for explaining a conventional technique for sectioning a pipeline of a processor;

FIGS. 2A and 2B are diagrams for explaining the conventional technique for sectioning the pipeline of the processor;

FIG. 3 is a diagram showing a first embodiment of a processor architecture according to the present invention;

FIG. 4 is a diagram for explaining a case where all program streams are operated;

FIG. 5 is a diagram for explaining a case where only one program stream is operated;

FIG. 6 is a diagram for explaining a case where M=2 in the first embodiment;

FIG. 7 is a diagram for explaining an operating state of a program stream 1 when M=2;

FIG. 8 is a diagram for explaining an operating state of a program stream 2 when M=2;

FIG. 9 is a diagram showing a second embodiment of the processor architecture according to the present invention;

FIG. 10 is a diagram for explaining an operating state of parallel instructions;

FIG. 11 is a diagram for explaining a clock control state when parallel instructions operate;

FIG. 12 is a diagram showing a third embodiment of the processor architecture according to the present invention;

FIG. 13 is a diagram showing a fourth embodiment of the processor architecture according to the present invention;

FIG. 14 is a diagram showing a fifth embodiment of the processor architecture according to the present invention;

FIG. 15 is a diagram showing a sixth embodiment of the processor architecture according to the present invention;

FIG. 16 is a diagram for explaining a clock control state when a program stream is operated for every S cycles;

FIG. 17 is a diagram showing an important part of a seventh embodiment of the processor architecture according to the present invention; and

FIG. 18 is a diagram for explaining a clock control state when ⅔ of pipeline stages operate in a bypass mode.

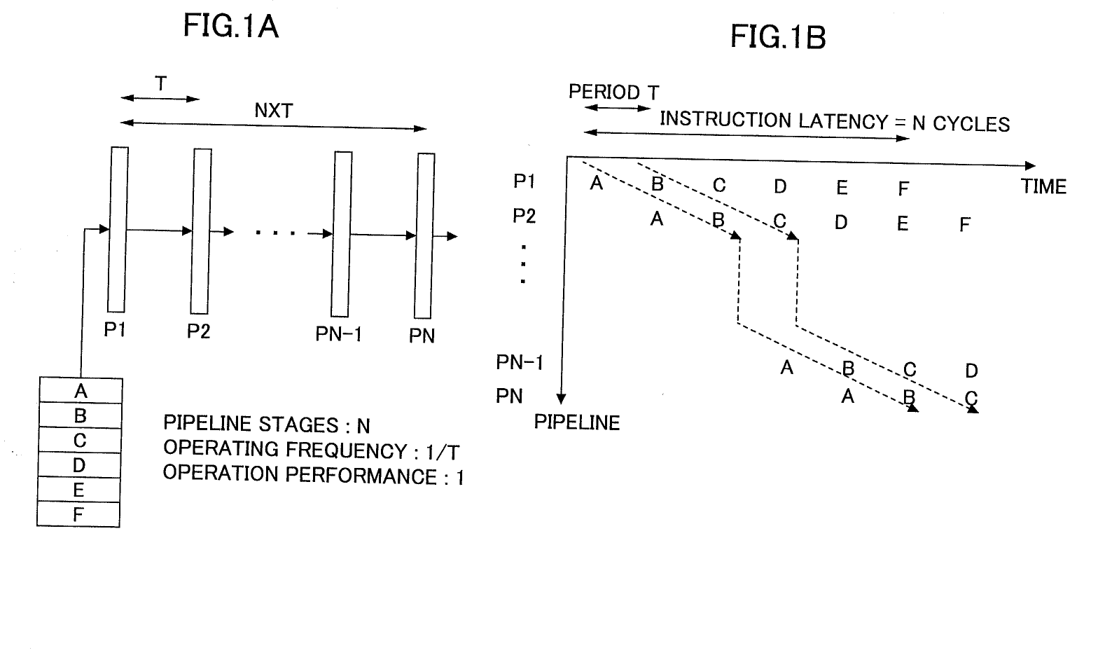

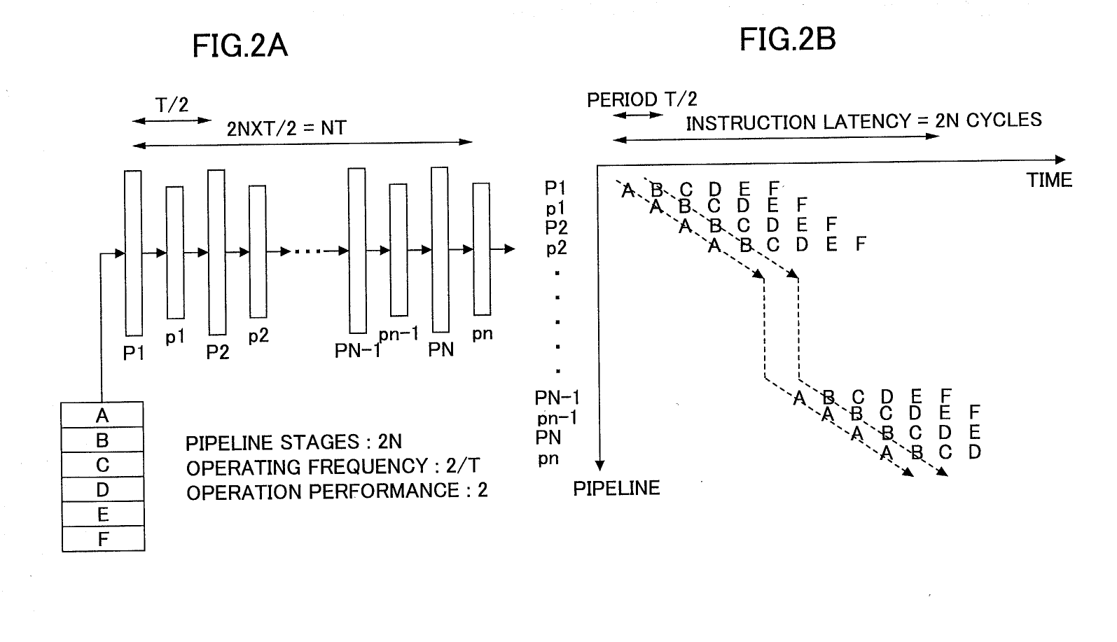

### DESCRIPTION OF THE PREFERRED EMBODIMENTS

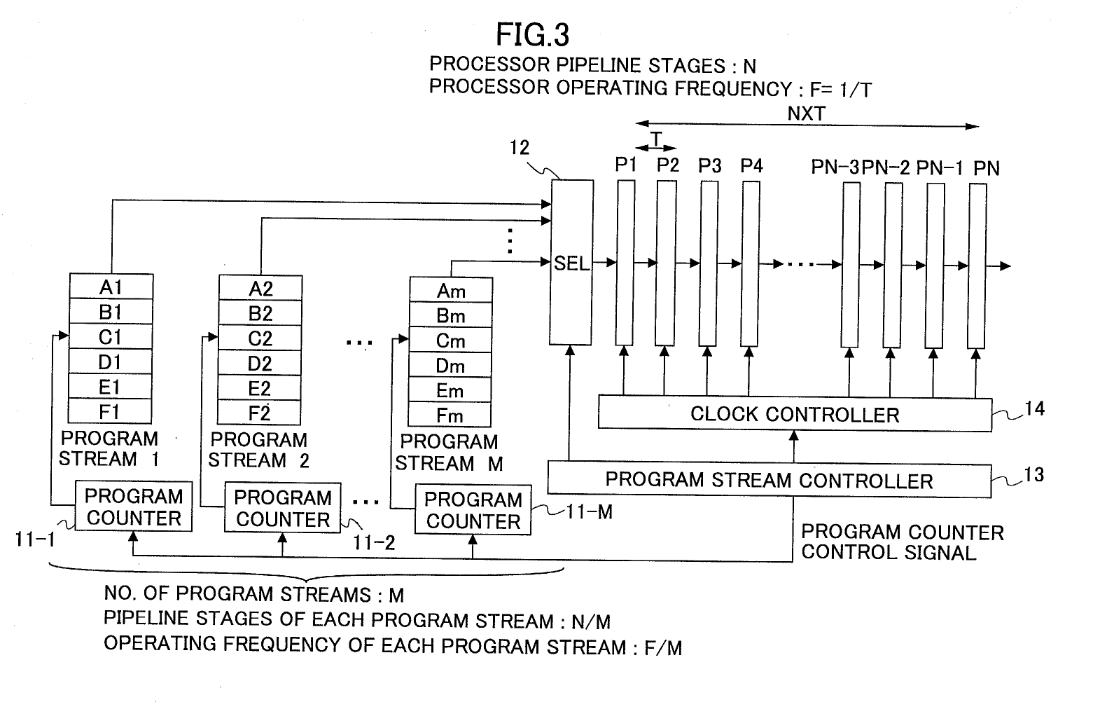

A description will now be given of various embodiments of a processor architecture according to the present invention, by referring to FIG. 3 and the subsequent drawings.

FIG. 3 is a diagram showing a first embodiment of the processor architecture according to the present invention. The processor shown in FIG. 3 includes program counters 11-1 through 11-M, a selector 12, a program stream selector 13, and a clock controller 14.

The program stream selector 13 has the functions of dynamically controlling the start, stop and switching of each of program streams 1 through M. When starting the program streams 1 through M, the program stream selector 13 supplies program control signals to the program counters 11-1 through 11-M so that initial values are loaded into the program counters 11-1 through 11-M in response to the program control signals. In addition, the program stream selector 13 supplies a control signal to the selector 12, so that the program streams 1 through M are successively selected and supplied to pipeline stages P1 through PN. Further, the program stream selector 13 carries out a control with respect to the clock controller 14, so as to cancel masking of clocks supplied to the pipeline stages P1 through PN. M and N respectively are arbitrary integers greater than or equal to one, and no mutually dependent relationship (that is, no mutual dependency) exists between M and N.

When stopping the program streams 1 through M, the program stream selector 13 carries out a control with respect to the clock controller 14, so as to set masking of the clocks supplied to the pipeline stages P1 through PN.

When switching the program streams 1 through M, the program stream selector 13 supplies program control signals to the program counters 11-1 through 11-M so that new values are loaded into the program counters 11-1 through 11-M in response to the program control signals. Moreover, the program stream selector 13 carries out a control with respect to the clock controller 14, so as to cancel masking of the clocks supplied to the pipeline stages P1 through PN.

The program stream selector 13 carries out the above described control independently with respect to each of the program streams 1 through M. In this case, the number of program streams is M, the apparent number of stages of the pipeline structure when viewed from each of the program streams 1 through M is N/M, the apparent operating frequency of each of the program streams 1 through M is F/M, the number of stages of the processor pipeline is N, the period of the pipeline is T, and the operating frequency of the processor is F=1/T.

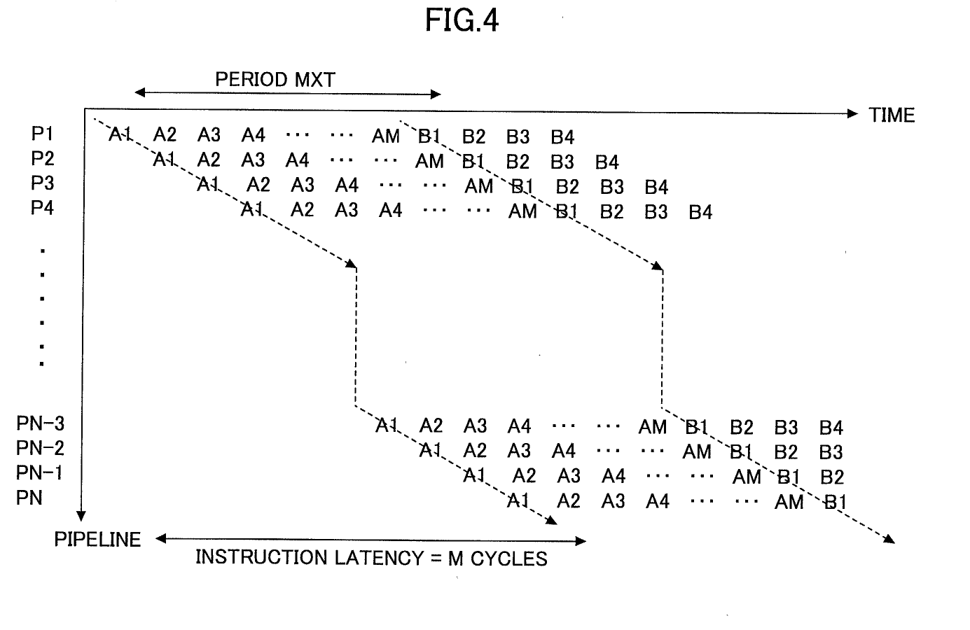

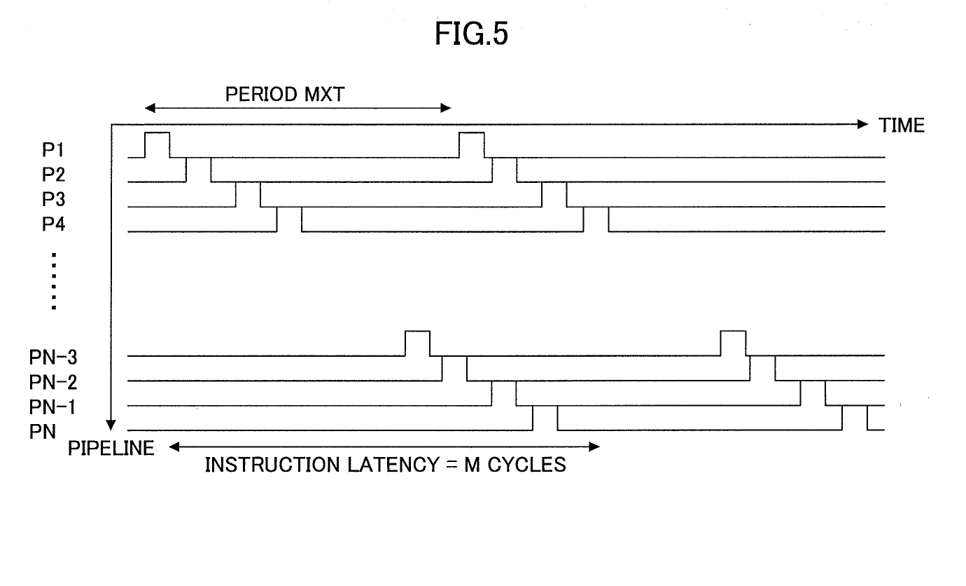

FIG. 4 is a diagram for explaining an operating state of the program streams, and shows a case where all of the program streams 1 through M are operated. In this case, the operating frequency of the processor is M×T, and the instruction latency is M cycles. On the other hand, FIG. 5 is a diagram for explaining an operating state of the program streams, and shows a case where only one of the program streams 1 through M is operated. In this case, the operating frequency of the processor is also M×T, and the instruction latency is also M cycles. The number of program streams which are executed depending on the operation performance required of the processor is denoted by s, and the number s may be set to an arbitrary integer greater than or equal to zero and satisfying s≦M.

In other words, this embodiment has a multi-stage pipeline structure, and the program counters 11-1 through 11-M time-divisionally execute the plurality of independent program streams 1 through M in units of one instruction with respect to the pipeline stages P1 through PN, so as to realize sharing of the pipeline stages P1 through PN. For this reason, it is possible to reduce the number of pipeline stages when viewed from each of the program streams 1 through M. Further, by taking into consideration the required operation performance and masking the clocks in cycles allocated to the program streams which do not need to operate, it is possible to reduce the power consumption.

In the case of the N-stage pipeline P1-PN capable of executing at the operating frequency F, if only a single program stream is executed, the number of pipeline stages is N with respect to this single program stream. However, in this embodiment, the M program streams 1 through M are time-divisionally executed in units of one instruction, and thus, each of the program streams 1 through M is executed in units of M cycles as shown in FIG. 4.

As a result, each of the program streams 1 through M is executed in units of M cycles, and the number of pipeline stages for each of the program streams 1 through M can be reduced to N/M, thereby enabling easy optimization of the instruction code. Furthermore, since it is possible to operate M processors having the operating frequency F/M in parallel, the operation performance of the processor can be improved owing to the combined effect of the instruction code optimization, when compared to a case where a single program stream is executed.

When not all of the operation performance is required, it is unnecessary to execute all of the M program streams 1 through M. Hence, only the program streams necessary to realize the required operation performance are implemented, and the clocks in the cycles allocated to the unnecessary program streams are masked, so as to reduce the power consumption. In other words, it is possible to select the operation performance and power consumption suited for each application, as may be seen from FIG. 5.

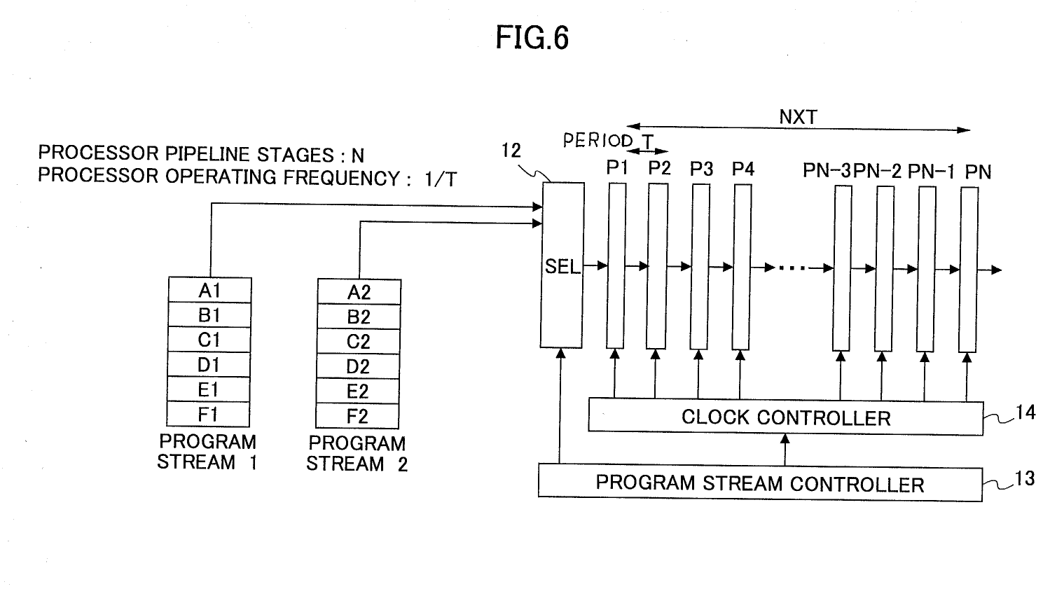

FIG. 6 is a diagram for explaining a case where M=2 in this first embodiment. In FIG. 6, those parts which are the same as those corresponding parts in FIG. 3 are designated by the same reference numerals, and a description thereof will be omitted. In addition, the illustration of the program counters is omitted in FIG. 6.

In this case shown in FIG. 6, the number of program streams is two, the number of pipeline stages of each of the program streams 1 and 2 is N/2, the operating frequency of each of the program streams 1 and 2 is F/2, the number of processor pipeline stages is N, the period of the pipeline is T, and the operating frequency of the processor is F=1/T.

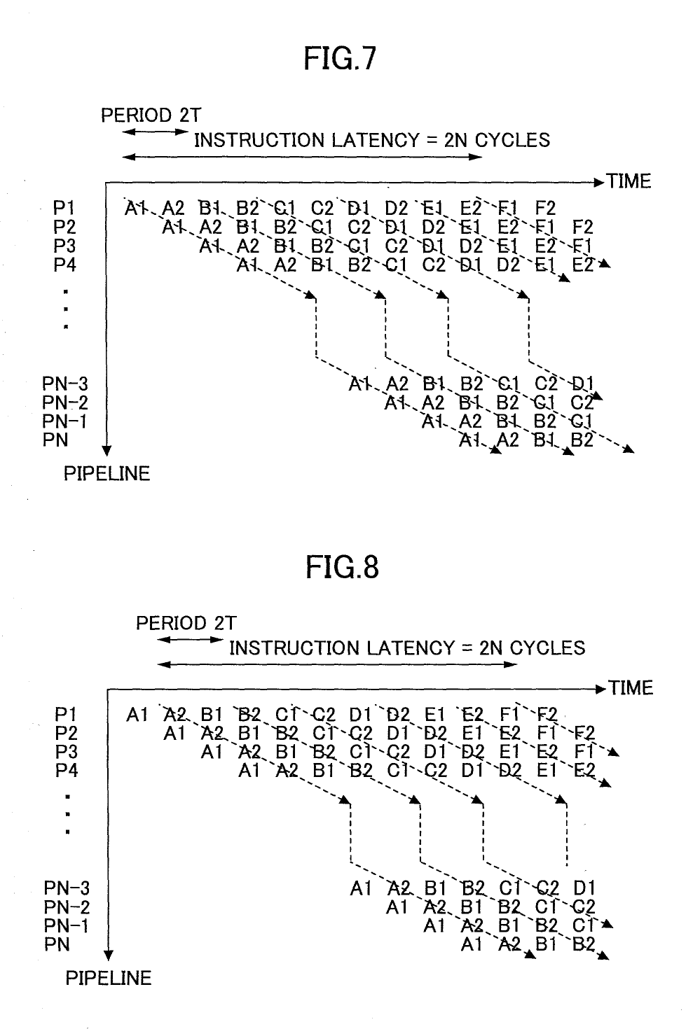

FIG. 7 is a diagram for explaining an operating state of the program stream 1 when M=2. In addition, FIG. 8 is a diagram for explaining an operating state of the program stream 2 when M=2. In this case, the operating period of the processor is 2×T, and the instruction latency is 2N cycles. In other words, two processors having an instruction latency of 2N carry out the parallel operations.

It is possible to realize an optimum microprocessor structure by taking the following measures for each application system.

First, when designing a system which requires a high operation performance such as signal processing, it is possible to execute each task by independent program streams as shown in FIG. 3, so as to realize a high operation performance. In addition, since each task can be executed independently, the tasks will not interfere with each other and deteriorate the executing performance.

Second, when designing a terminal system which is installed with an operating system (OS), multiple tasks (or multi-task operation) can be realized by implementing the OS in one program stream and implementing a necessary program in another program stream. In addition, by masking the clocks in the cycles which are allocated to the program streams which do not need to be executed, it is possible to reduce the power consumption. In other words, when executing M program streams in time division, the power consumption becomes approximately 1/M that for the case where all of the M program streams are executed if only the OS is executed by one program stream, as may be seen from FIG. 5. Moreover, since the OS can freely add or delete tasks, the power consumption can be adaptively controlled proportionally to the number of operating tasks.

Third, when designing a system which requires low power consumption but only requires a low operation performance, it is unnecessary to execute all of the M program streams, similarly to the above described case where only the OS is executed by one program stream. Accordingly, the power consumption can be reduced by implementing only the program streams which are sufficient to satisfy the required operation performance, and masking the clocks in the cycles in which the unnecessary program streams are allocated. In other words, it is possible to select the operation performance and power consumption suited for the application.

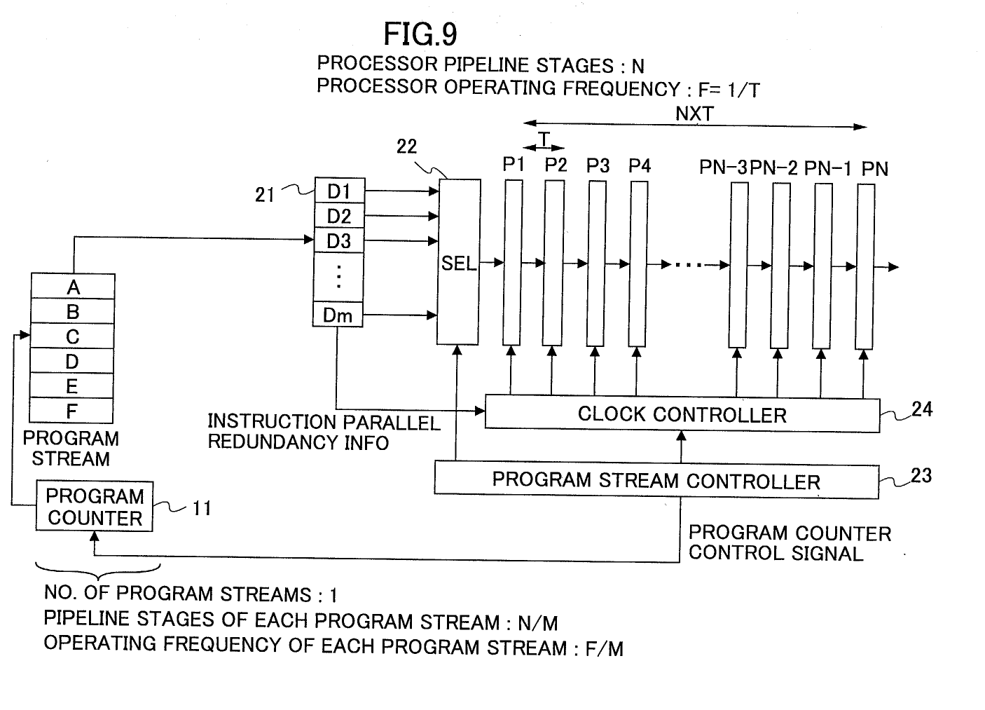

FIG. 9 is a diagram showing a second embodiment of the processor architecture according to the present invention. The processor shown in FIG. 9 includes a program counter 11, an instruction developing section 12, a selector 22, a program stream selector 23, and a clock controller 24.

The program stream selector 23 has the functions of dynamically controlling the start, developing and switching of one program stream 1. When starting the program stream 1, the program stream selector 23 supplies a program control signal to the program counter 11 so that an initial value is loaded into the program counter 11 in response to the program control signal.

When developing the program stream 1, the instruction developing section 21 expands one instruction of the program stream 1 into Q parallel instructions, and supplies the Q parallel instructions to the selector 22. The program stream selector 23 supplies a control signal to the selector 22 so that the selector 22 successively selects the Q parallel instructions from the instruction developing section 21 and supplies the Q parallel instructions to the pipeline stages P1 through PN. The program stream selector 23 also carries out a control with respect to the clock controller 24, so as to set masking of the clocks supplied to the pipeline stages P1 through PN based on instruction parallel redundancy information from the instruction developing section 21.

When switching the program stream 1, the program stream selector 23 supplies a program control signal to the program counter 11 so that a new value is loaded into the program counter 11 in response to the program control signal. The program stream selector 23 also carries out a control with respect to the clock controller 24, so as to cancel the masking of the clocks supplied to the pipeline stages P1 through PN.

The program stream selector 23 carries out the above described control with respect to the program stream 1. In this case, the number of program streams is one, the apparent number of pipeline stages of the program stream 1 is N/M, the apparent operating frequency of the program stream 1 is F/M, the number of processor pipeline stages is N, the period of the pipeline is T, and the operating frequency of the processor is F=1/T.

Therefore, in this embodiment, instead of time-divisionally executing M program streams as in the case of the first embodiment, only the single program stream 1 is executed, no instruction is executed in the cycles allocated for the remaining M−1 program streams, and one instruction is expanded into Q (Q≦M) parallel instructions and the Q parallel instructions are selectively executed in the remaining M−1 cycles. For this reason, it is possible to locally execute instructions at a high speed in units of instructions, by consecutively executing Q cycles in time division.

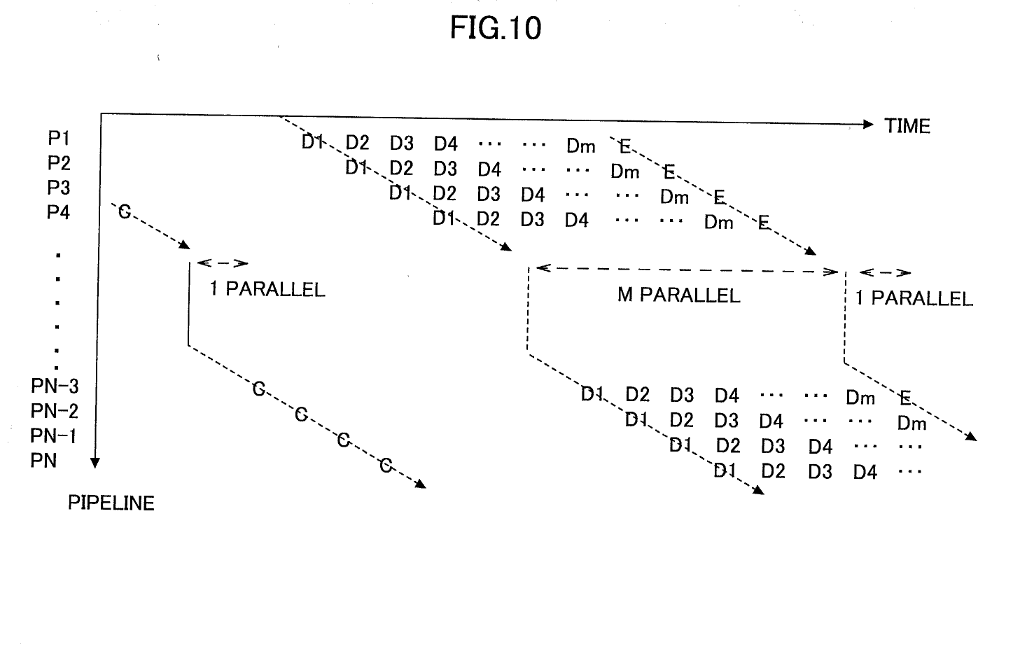

FIG. 10 is a diagram for explaining an operating state of the parallel instructions. As may be seen from FIG. 10, by embedding instructions which can be executed in parallel within the single program stream 1 and executing such instructions, the processor operates at an operating frequency F/M when the parallel redundancy is one. But when the parallel redundancy can be utilized usefully at the instruction level, it is possible to execute a maximum of M parallel instructions, and the processor can be operated locally at M times the performance.

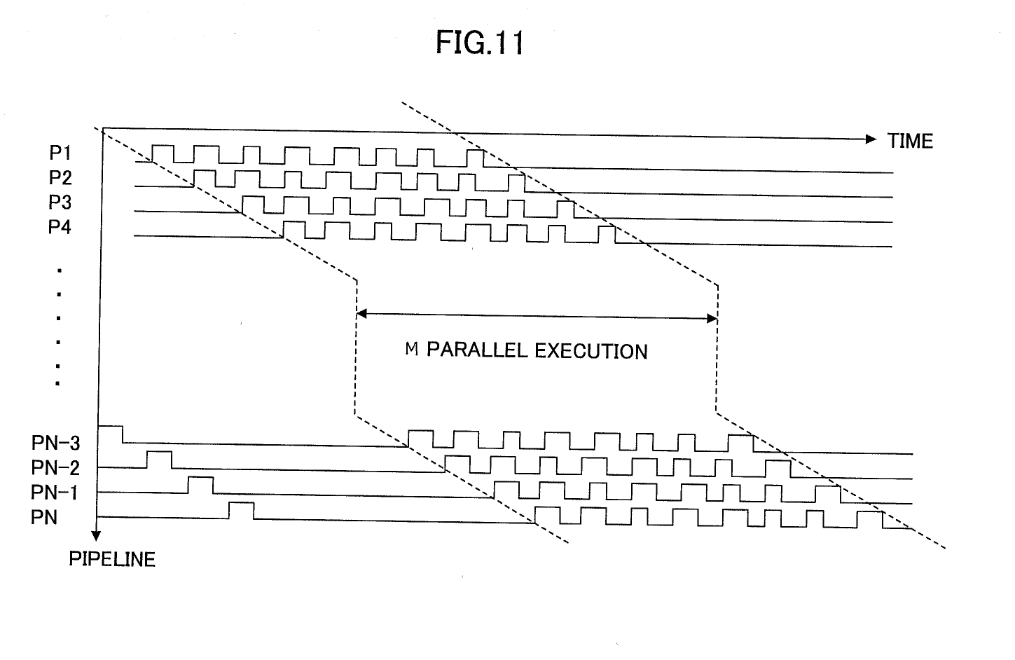

When the instruction parallel redundancy information in units of instructions is supplied from the instruction developing section 21 to the clock controller 24, the clocks in the cycles in which the parallel redundancy cannot be utilized usefully, of the clocks which are supplied from the clock controller 24 to the pipeline stages P1 through PN, can be masked so as to reduce the power consumption. FIG. 11 is a diagram showing a clock control state when parallel instructions operate.

It is possible to combine the first and second embodiments described above, so as to execute a plurality of program streams in parallel, while executing parallel instructions in each of the individual program streams, as in the case of a third embodiment which will be described hereunder.

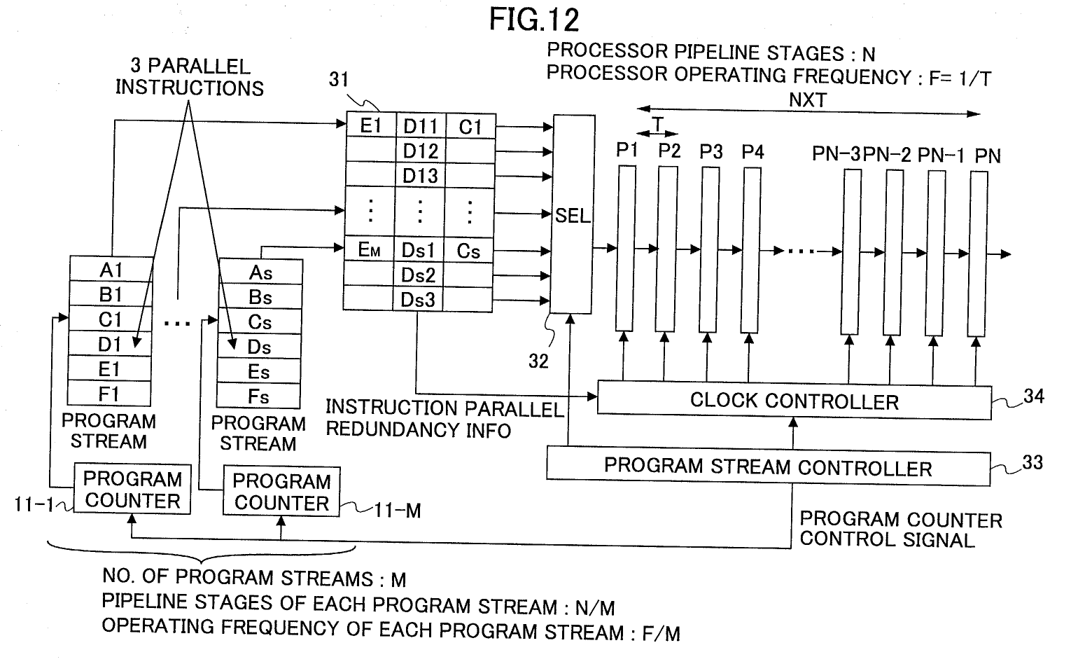

FIG. 12 is a diagram showing the third embodiment of the processor architecture according to the present invention. The processor shown in FIG. 12 includes program counters 11-1 through 11-M, an instruction developing section 31, a selector 32, a program stream selector 33, and a clock controller 34. For the sake of convenience, it is assumed in FIG. 12 that three parallel instructions are executed when executing the parallel instructions in each of the individual program streams.

The program stream selector 33 has the functions of dynamically controlling the start, developing and switching of M program streams 1 through M. When starting each of the program streams 1 through M, the program stream selector 33 supplies program control signals to the program counters 11-1 through 11-M, so that initial values are loaded into the program counters 11-1 through 11-M in response to the program control signals.

When developing each of the program streams 1 through M, the instruction developing section 31 expands one instruction of each of the program streams 1 through M into Q parallel instructions, and supplies the Q parallel instructions to the selector 32. The program stream selector 33 supplies a control signal to the selector 32, so that the selector 32 successively selects the Q parallel instructions from the instruction developing section 31 and supplies the Q parallel instructions to the pipeline stages P1 through PN. Further, the program stream selector 33 carries out a control with respect to the clock controller 34, so as to set masking of the clocks supplied from the instruction developing section 31 to the pipeline stages P1 through PN based on the instruction parallel redundancy information.

When switching each of the program streams 1 through M, the program stream selector 33 supplies program control signals to the program counters 11-1 through 11-M so as to load new values into the program counters 11-1 through 11-M in response to the program control signals. The program stream selector 33 also carries out a control with respect to the clock controller 34 so as to cancel the masking of the clocks supplied from the instruction developing section 31 to the pipeline stages P1 through PN based on the instruction parallel redundancy information.

The program stream selector 33 carries out the above described control with respect to each of the program streams 1 through M. In this case, the number of program streams is M, the apparent number of pipeline stages of each of the program streams a through M is N/M, the apparent operating frequency of each of the program streams 1 through M is F/M, the number of processor pipeline stages is N, the period of the pipeline is T, and the operating frequency of the processor is F=1/T.

Therefore, according to this embodiment, it is possible to execute a plurality of program streams in parallel while executing the parallel instructions in each of the individual program streams, by combining the first and second embodiments described above. Consequently, it is possible to locally execute instructions at a high speed in units of instructions, with respect to each of the program streams.

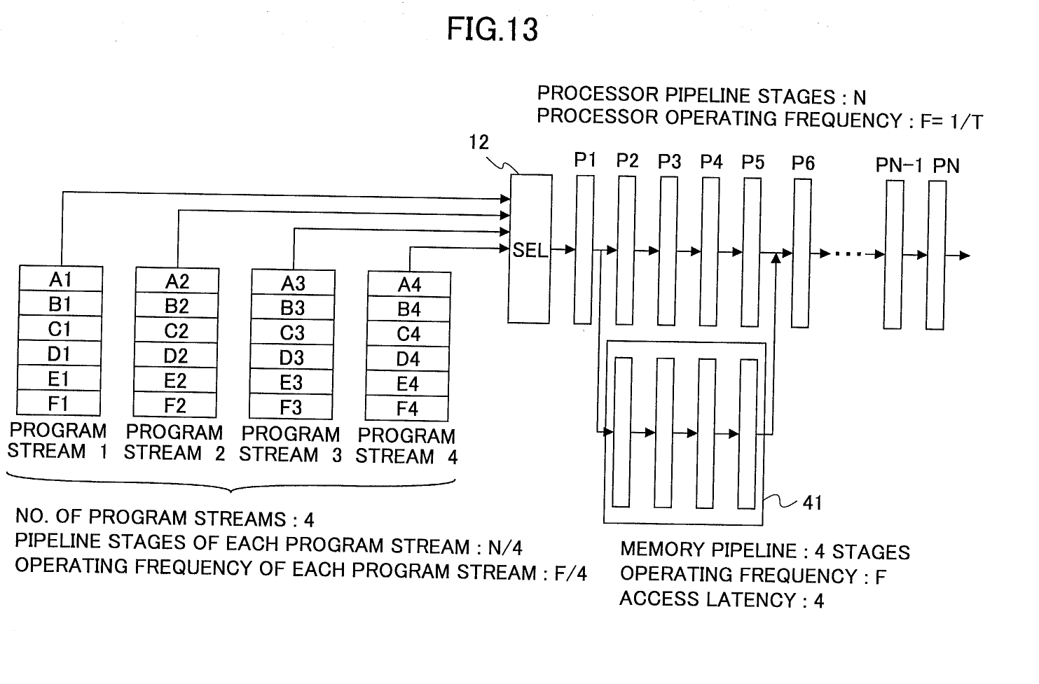

FIG. 13 is a diagram showing a fourth embodiment of the processor architecture according to the present invention. In FIG. 13, those parts which are the same as those corresponding parts in FIG. 3 are designated by the same reference numerals, and a description thereof will be omitted. In addition, the illustration of the program counters is omitted in FIG. 13.

In this embodiment, it is assumed for the sake of convenience that M=4, that is, the number of program streams is four. In addition, it is assumed that the access latency is L cycles (L≧1), the operating frequency is F, and a memory 41 having a structure capable of making a pipeline-like consecutive access (that is, having a throughput of one cycle) is embedded in the pipeline P1-PN of the processor. It is also assumed for the sake of convenience that the number of pipeline stages of the memory 41 is four, that is, L=4. In this case, the number of pipeline stages of each of the program streams 1 through 4 is N/4, the operating frequency of each of the program streams 1 through 4 is F/4, the number of processor pipeline stages is N, the period of the pipeline is T, and the operating frequency of the processor is F=1/T.

Accordingly, the apparent memory access latency of each of the program streams 1 through 4 can be reduced to 1/M=¼, and a single memory can be shared by a plurality of (M) processors.

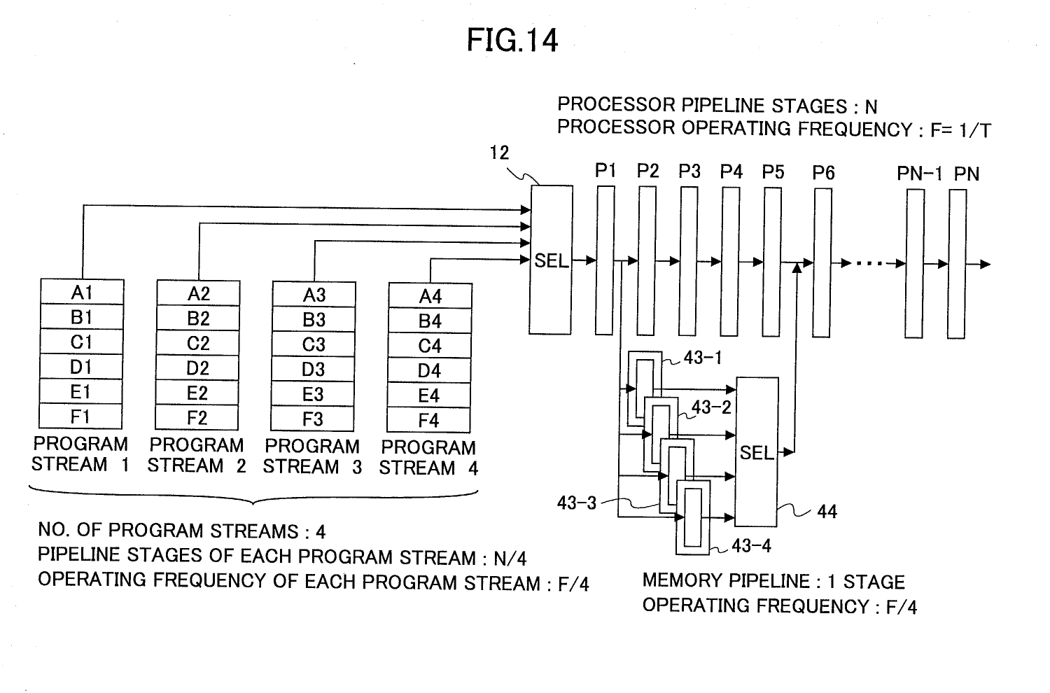

FIG. 14 is a diagram showing a fourth embodiment of the processor architecture according to the present invention. In FIG. 14, those parts which are the same as those corresponding parts in FIG. 3 are designated by the same reference numerals, and a description thereof will be omitted. The illustration of the program counters is omitted in FIG. 14.

In this embodiment, it is assumed for the sake of convenience that M=4, that is, the number of program streams is four. In addition, it is assumed that the access latency is L cycles (L≧1), the operating frequency is F/4, and memories 43-1 through 43-4 respectively having a structure capable of making a pipeline-like consecutive access (that is, having a throughput of one cycle) and a selector 44 are embedded in the pipeline P1-PN of the processor. It is also assumed for the sake of convenience that the number of pipeline stages of each of the memories 43-1 through 43-4 is one, that is, L=1. In this case, the number of pipeline stages of each of the program streams 1 through 4 is N/4, the apparent operating frequency of each of the program streams 1 through 4 is F/4, the number of processor pipeline stages is N, the period of the pipeline is T, and the operating frequency of the processor is F=1/T.

Accordingly, the apparent memory access latency of each of the program streams 1 through 4 can be reduced to F/M. Hence, even if the operating frequency of each of the memories 43-1 through 43-4 is reduced to 1/M=¼, it is possible to reduce the power consumption while maintaining approximately the same access performance when compared to the third embodiment described above.

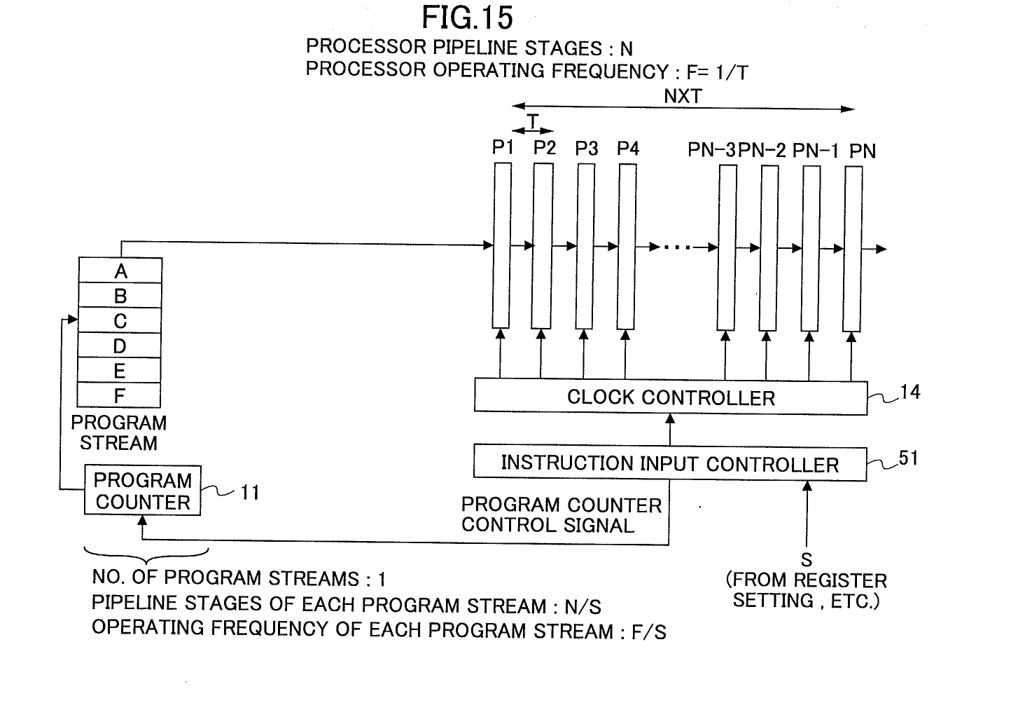

FIG. 15 is a diagram showing a fifth embodiment of the processor architecture according to the present invention. In FIG. 15, those parts which are the same as those corresponding parts in FIGS. 3 and 9 are designated by the same reference numerals, and a description thereof will be omitted.

This embodiment is provided with an instruction input controller 51. This instruction input controller 51 carries out a control to input the instruction for every S (S−1) cycles, when executing one program stream. S is variable. S is set in a register (not shown) or the like, and is input to the instruction controller 51. Hence, it is possible to set the performance of the processor to 1/S depending on the performance required of the processor.

In this case, the number of program streams is one, the apparent number of pipeline stages of the program stream is N/S, the apparent operating frequency of the program stream is F/S, the number of processor pipeline stages is N, the period of the pipeline is T, and the operating frequency of the processor is F=1/T.

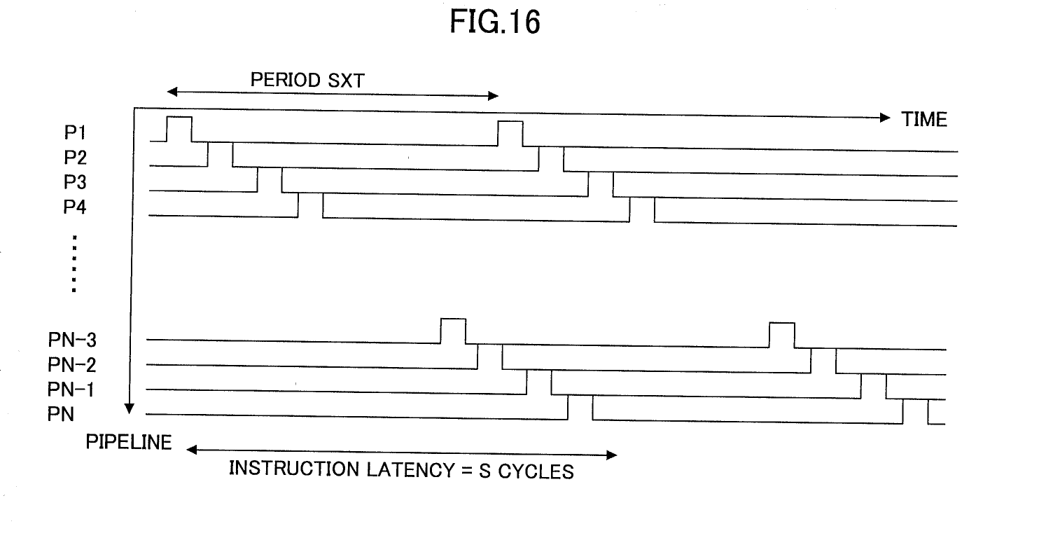

FIG. 16 is a diagram for explaining a clock control state for a case where the program stream is operated for every S cycles. In this case, the operating period of the processor is S×T, and the instruction latency is S cycles. With respect to (S−1) cycles in which the instruction is not input, the instruction input controller 51 can control the clock controller 14, so as to reduce the operating frequency by masking the clocks which are originally required for the operation in these cycles. Therefore, it is possible to reduce the power consumption, as may be seen from FIG. 16. In other words, it is possible to control the power consumption to suit the performance required of the processor.

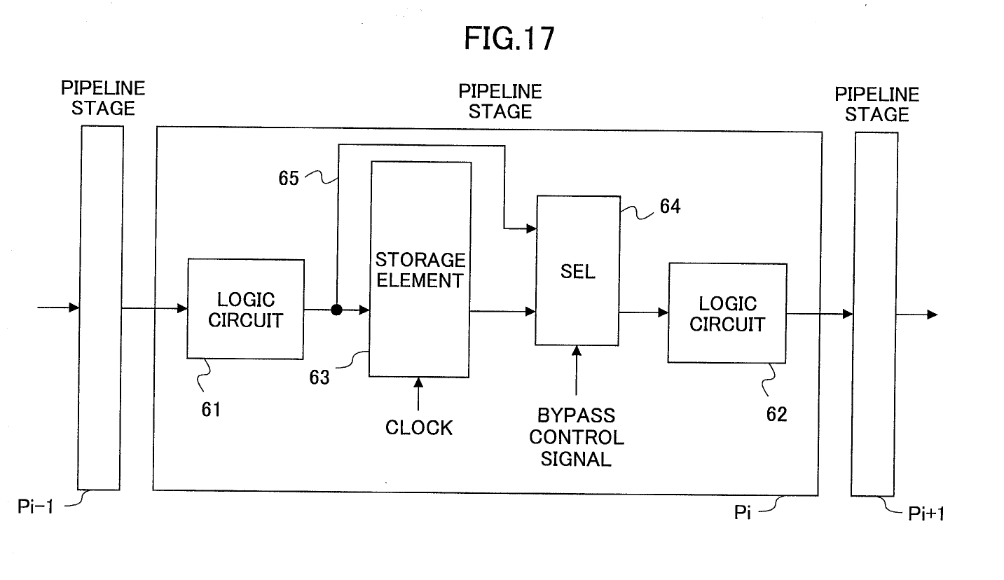

FIG. 17 is a diagram showing an important part of a seventh embodiment of the processor architecture according to the present invention. In FIG. 17, those parts which are the same as those corresponding parts in FIG. 15 are designated by the same reference numerals, and a description thereof will be omitted. In FIG. 17, the structure of only a stage Pi (i=2, . . . , N−1) of the pipeline P1-PN is shown for the sake of convenience, but the other pipeline stages have similar structures.

In FIG. 17, the pipeline stage Pi includes logic circuits 61 and 62, a storage element 63, a selector 64, and a bypass 65. Input data from a pipeline stage Pi−1 of a preceding stage is supplied to the selector 64 via the logic circuit 61 and the storage element 63 on one hand, and supplied to the selector 64 via the logic circuit 61 and the bypass 65 on the other. The selector 64 supplies the data from the storage element 63 or the bypass 65 to the logic circuit 62 in response to a bypass control signal, and an output of the logic circuit 62 is supplied to a pipeline stage Pi+1 of a subsequent stage.

In other words, each pipeline stage has two operating modes, namely, an operating mode for storing and holding the input data and an operating mode for bypassing and outputting the input data. In the bypass mode, the storage element 63 is not operated, and the clock is masked by the clock controller 14 (not shown in FIG. 17).

When carrying out a control so as to input the instruction for every S cycles (S≧1), there exists, of the N pipeline stages P1 through PN, a pipeline stage which will not change the operation even if the input data is bypassed and not held, that is, a pipeline stage which can be combined with a preceding pipeline stage. By setting the operating mode of such a pipeline stage to the bypass mode by supplying the bypass control signal to the selector 64 of this pipeline stage and bypassing the storage element 63, it is possible to reduce the power consumption by an amount corresponding to the power required to carry out the storing and holding operation. In other words, it is possible to substantially reduce the number of pipeline stages by using the bypass mode in one or a plurality of pipeline stages, and it is possible to reduce the power consumption by realizing a stage which is equivalent to reducing the operating frequency. The combining of the pipeline stages may be made consecutively for more than two stages.

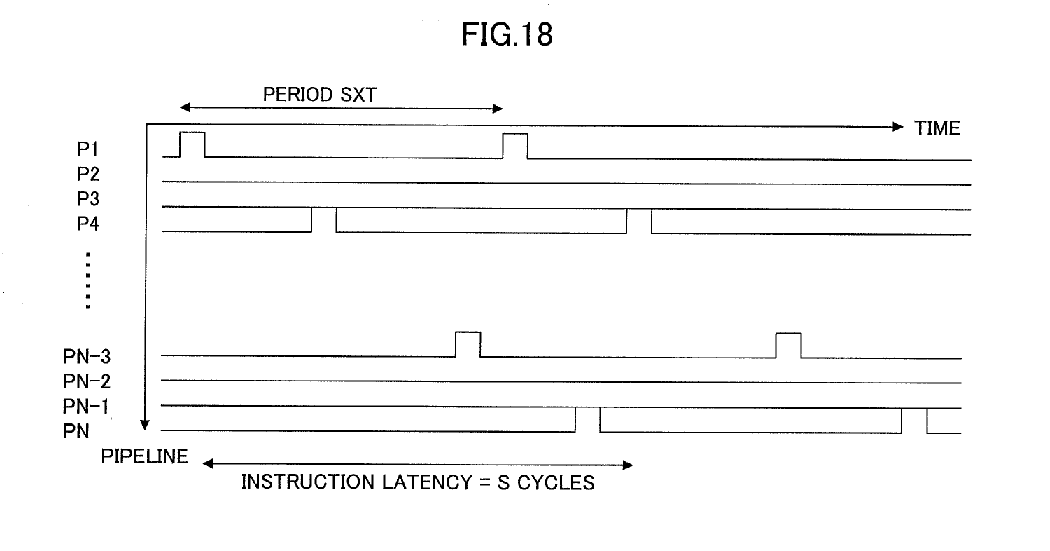

FIG. 18 is a diagram for explaining a clock control stage when ⅔ of the pipeline stages operate in the bypass mode. In other words, FIG. 18 shows a case where the pipeline stages are combined for every three pipeline stages. In this case, the operating period of the processor is S×T, and the instruction latency is S cycles. In the case shown in FIG. 18, it may be seen that the operating frequency can further be reduced without deteriorating the performance of the processor when compared to the sixth embodiment shown in FIG. 16.

The bypass control signal may be generated by the instruction input controller 51 shown in FIG. 15 based on the value of the instruction input cycle S. In addition, although the logic circuits 61 and 62 are respectively provided at stages before and after the storage element 63, this structure may be modified arbitrarily. Moreover, the pipeline P1-PN having the bypass mode may similarly be applied to each of the embodiments described above.

Therefore, according to the present invention, it is possible to realize a processor architecture which can reduce the power consumption depending on the performance required of the processor, by executing the program streams to suit the performance required of the processor.

Further, the present invention is not limited to these embodiments, but various variations and modifications may be made without departing from the scope of the present invention.

### What is claimed is

1. A processor architecture comprising:
a program counter executing M independent program streams in time division in units of one instruction;
a pipeline, shared by each of the program streams, having N pipeline stages operable at a frequency F; and
a first mechanism executing only s program streams depending on a required operation performance,
where M and N are integers greater than or equal to one and having no mutual dependency, s is an integer greater than or equal to zero and satisfying s≦M, and
an apparent number of pipeline stages viewed from each of the program streams is set to N/M so that M parallel processors having an apparent operating frequency F/M are formed.

2. The processor architecture as claimed in claim 1, further comprising:
a second mechanism dynamically starting, stopping and switching each of the program streams.

3. The processor architecture as claimed in claim 1, wherein said first mechanism includes a clock controller which masks clocks supplied to each of the stages of the pipeline in cycles allocated to (M−s) program streams which require no execution.

4. The processor architecture as claimed in claim 1, wherein each of the pipeline stages of said pipeline includes a storage element, and has an operating mode for storing and holding input data in the storage element and an operating mode for bypassing the storage element and outputting the input data.

5. The processor architecture as claimed in claim 1, wherein:
said pipeline has an access latency of L cycles, an operating frequency F, and a memory having a structure capable of making a pipeline-like consecutive access,
where L≧1, and a memory access latency in one program stream is L/M.

6. The processor architecture as claimed in claim 1, wherein:
said pipeline has an access latency of L cycles, and M memories each having a structure capable of making a pipeline-like consecutive access independently with respect to each program stream, where L≧1.

7. A processor architecture comprising:
a program counter executing M independent program streams in time division in units of one instruction;
a pipeline, shared by each of the program streams, having N pipeline stages operable at a frequency F;
an instruction developing section which develops one instruction into Q parallel instructions; and
a first mechanism executing one program stream for every M cycles depending on a required operation performance and selectively executing the Q parallel instructions in remaining (M−1) cycles,
where M and N are integers greater than or equal to one and having no mutual dependency, Q is an integer greater than or equal to one and satisfying Q≦M, and
an apparent number of pipeline stages viewed from each of the program streams is set to N/M so that M parallel processors having an apparent operating frequency F/M are formed.

8. The processor architecture as claimed in claim 7, further comprising:
a second mechanism dynamically starting, stopping and switching each of the program streams.

9. The processor architecture as claimed in claim 7, wherein said first mechanism includes a clock controller which masks clocks supplied to each of the stages of the pipeline in cycles allocated to (M−s) program streams which require no execution, where s is an integer greater than or equal to zero and satisfying s≦M.

10. The processor architecture as claimed in claim 7, wherein said first mechanism consecutively executes the Q parallel instructions in cycles allocated to (M−s) program streams which require no execution so as to locally execute the instructions at a high speed, where s is an integer greater than or equal to zero and satisfying s≦M.

11. The processor architecture as claimed in claim 7, wherein each of the pipeline stages of said pipeline includes a storage element, and has an operating mode for storing and holding input data in the storage element and an operating mode for bypassing the storage element and outputting the input data.

12. The processor architecture as claimed in claim 7, wherein:
said pipeline has an access latency of L cycles, an operating frequency F, and a memory having a structure capable of making a pipeline-like consecutive access,
where L≧1, and a memory access latency in one program stream is L/M.

13. The processor architecture as claimed in claim 7, wherein:
said pipeline has an access latency of L cycles, and M memories each having a structure capable of making a pipeline-like consecutive access independently with respect to each program stream, where L≧1.

14. A processor architecture comprising:
a pipeline operable at a frequency F and having N pipeline stages; and
a mechanism which inputs an instruction for every S cycles depending on a required operation performance and masking clocks supplied to said pipeline in remaining cycles in which no instruction is input, when executing one program stream,
where N and S are integers greater than or equal to one and having no mutual dependency, and
an apparent number of pipeline stages of said pipeline when viewed from the program stream is set to N/S so that a processor having an apparent operating frequency F/S is formed.

15. The processor architecture as claimed in claim 14, wherein:
each of the pipeline stages of said pipeline includes a storage element, and has an operating mode for storing and holding input data in the storage element and an operating mode for bypassing the storage element and outputting the input data, and
said mechanism masks a clock supplied to the storage element within a pipeline stage which is combinable with a preceding pipeline stage.

16. The processor architecture as claimed in claim 14, wherein:
said pipeline has an access latency of L cycles, an operating frequency F, and a memory having a structure capable of making a pipeline-like consecutive access,
where L≧1, and a memory access latency in one program stream is L/M.

17. The processor architecture as claimed in claim 14, wherein:
said pipeline has an access latency of L cycles, and M memories each having a structure capable of making a pipeline-like consecutive access independently with respect to each program stream, where L≧1.
